(19) United States
(12) Patent Application Publication
(10) Pub. No.: US 2024/0409410 A1
(43) Pub. Date: Dec. 12, 2024

(54) COMPOSITE MATERIAL, THE METHOD OF ITS PREPARATION AND APPLICATION THEREOF

(71) Applicant: Uniwersytet Jagiellonski, Kraków (PL)

(72) Inventors: Monika BAKIERSKA, Suwalki (PL); Marcelina KUBICKA, Czarna (PL); Marcin MOLENDA, Kraków (PL); Jakub BIELEWSKI, Kraków (PL); Krystian CHUDZIK, Jedrzejów (PL)

(73) Assignee: Uniwersytet Jagiellonski, Kraków (PL)

(21) Appl. No.: 18/697,504

(22) PCT Filed: Oct. 3, 2022
(86) PCT No.: PCT/PL2022/050062

§ 371 Date: Apr. 1, 2024

(30) Foreign Application Priority Data
Oct. 1, 2021 (PL) P.439111

(51) Int. Cl. C01B 32/05; B01J 13/00; H01M 10/0525

(52) U.S. Cl. CPC C01B 32/05; B01J 13/0091; H01M 10/0525; C01P 2002/08; C01P 2002/32; C01P 2004/64; C01P 2006/12; C01P 2006/14; C01P 2006/40

(57) ABSTRACT

A stressed composite material is disclosed, characterized in that it contains Li₄Ti₅O₁₂ spinel nanocrystallites in an amount of 25-93% by weight, encapsulated during the pyrolysis process in a tightly adherent and conductive carbon aerogel matrix with a carbon content of 7-74% by weight, with a specific surface area of the composite of 44-426 m²/g, and a pore volume of the composite of 0.03-0.21 cm³/g, and an average pore size of the composite of 2-3 nm. Also disclosed is a method for obtaining the stressed composite material and an application of the stressed composite material for manufacturing electrode materials and lithium-ion cells.

The invention relates to a stressed composite material based on the carbon aerogel (CAG)/spinel-type lithium-titanium oxide (Li₄Ti₅O₁₂, LTO) composite system, the method of its preparation and application thereof. The composite material produced according to the invention can be used in the production of electrode materials, in particular for the manufacture of lithium-ion cells.

An LTO/C composite is known from US patent description U.S. Pat. No. 9,520,240 B2, whereby the carbon can be a carbon aerogel. The composite contains 80-90% of LTO/C, 5-15% of a conductive agent and 1-5% of a binder. The method of manufacturing the LTO/carbon composite includes the steps of preparing the material, mixing the material by ultrasonic or mechanical method, drying the mixture in an oven or by spray drying, carrying out heat treatment of the dried mixture at 700 to 900° C. in a nitrogen or argon atmosphere to produce LTO granules and introducing the carbon-based additive into a number of voids in the LTO granules.

An anode material in the form of C/LTO is known from the scientific publication titled “High rate performance of the carbon encapsulated Li₄Ti₅O₁₂ for lithium ion battery”, published in Results in Physics 7 (2017) 810-812, where the amount of carbon is estimated at 5%, and the material is characterized by a higher capacity compared to pure LTO containing no carbon.

A nitrogen-modified LTO/graphene composite is known from the scientific publication titled “Enhanced electrochemical performance of a LTO/N-doped graphene composite as an anode material for Li-ion batteries”, published in Solid State Ion. 2017, 311, 98-104, that is characterized by improved electrochemical performance compared to pure LTO, as well as to an LTO/graphene composite.

An LTO/graphene oxide (GO) composite is known from the scientific publication titled “High-rate-capability graphene oxide/Li₄Ti₅O₁₂-composite anode for lithium-ion batteries”, published in Int. J. Electrochem. Sci, 2017, 12, 2822-2835, that is characterized by a higher capacity and charging rate compared to pure LTO. Moreover, the GO/LTO composite retained a higher initial capacity after 200 cycles at high speed compared to pure LTO.

Electrode materials that have been disclosed in the state of the art that are characterized by good conductivity and better specific capacity in relation to pure lithium-titanium oxide LTO, however, they do not show adequate capacity retention (durability). Moreover, during manufacture of the electrode materials, many side phases are formed at the boundaries of LTO grains, which consequently leads to a loss of specific capacity, as well as results in deformations and stress in the LTO structure due to the process of excessive lithiation. Furthermore, in carbon/LTO composites, insufficient adhesion of the LTO spinel to the carbon coatings is problematic, as well as the limitation of lithium ion permeability (limitation of ion diffusion channels and electrolyte penetration) in the case of increased composite thickness necessary to achieve adequate mechanical properties. Another problem in the state of the art is the inability to control the structure and the morphology and electrochemical properties of the composites produced. There is also a limitation on the amount of lithium introduced into LTO and limited intercalation of lithium ions into the carbon structure due to structural reasons (occurrence of deformations and stress). Many existing anode materials are also characterized by low Coulombic reversibility and low efficacy of cell operation under high-current conditions, which contributes to overwear of the anode materials.

Unexpectedly, the above-mentioned technical problems have been solved in the present invention.

The subject of the invention is a composite material, characterized in that it contains a matrix formed by a carbon aerogel and Li₄Ti₅O₁₂ spinel nanocrystallites dispersed in this matrix, with a carbon content in the composite of 7-74% by weight and a content of Li₄Ti₅O₁₂ spinel nanocrystallites in the composite of 25-93% by weight, with a specific surface area of the composite of 44-426 m²/g, and a pore volume of the composite of 0.03-0.21 cm³/g, and an average pore size of the composite of 2-3 nm.

Preferably, the composite material is characterized in that the Li₄Ti₅O₁₂ nanocrystallites have a size in the range of 40-70 nm.

Another subject of the invention is a method for obtaining a composite material, characterized in that an aqueous suspension containing Li₄Ti₅O₁₂ in an amount of 5-75% by weight and potato starch in an amount of 25-95% by weight undergoes a polycondensation process at 60-90° C., and then the obtained hydrogel is subjected to aging, followed by solvent exchange using an aqueous alcohol solution, and then the obtained alkogel is dried, and the dried gel is subjected to pyrolysis at 600-900° C.

Preferably, the method is characterized in that the polycondensation is carried out at temperatures up to 85° C.

Preferably, the method is characterized in that the polycondensation is carried out until a gel is obtained.

Preferably, the method is characterized in that the aging process is carried out for not less than 24 h.

Preferably, the method is characterized in that the aging process is carried out at room temperature and at atmospheric pressure.

Preferably, the method is characterized in that the solvent exchange process is carried out using an aqueous alcohol solution of a concentration in the range of 10-99.8%.

Preferably, the method is characterized in that an alcohol selected from the group including methanol, ethanol, propanol or a mixture thereof of any composition is used as the alcohol.

Preferably, the method is characterized in that the pyrolysis is carried out under inert gas conditions or under reducing gas conditions.

Preferably, the method is characterized in that a gas selected from the group including nitrogen, argon, helium or a mixture of these gases of any composition is used as the inert gas.

Another subject of the invention is the use of a stressed composite material for the manufacturing of electrode materials and lithium-ion cells.

LTO (Li₄Ti₅O₁₂) is a promising material, considered a possible replacement for the currently most widely used carbon anodes [1-5]. It has a number of advantages such as excellent stability, non-toxicity and relatively low production cost. Moreover, during the intercalation and deintercalation of lithium ions into its structure, there is virtually no change in its volume, which translates into high cycling of this material without loss of performance [6]. However, since lithium-titanium oxide has low conductivity, it cannot be used in batteries in pure form. Another disadvantage of this material is its rather low specific capacity. When LTO is charged in the typical potential range, i.e. ˜1.0-2.5 V vs. Li⁺/Li, the lithium ions initially present in the structure move from occupied tetrahedral sites (8a) to octahedral sites (16c). This leads to complete occupation of the 16c sites after charging and an increase in the number of vacant sites in the 8a positions [7]. In this state, the material contains three additional lithium ions to form the Li₇Ti₅O₁₂ phase, resulting in a theoretical capacity of only 175 mAh/g [8]. To improve the low electrical conductivity, LTO can be coated with a conductive material, such as carbon [9], or conductive additives can be used during the electrode preparation process [10].

On the other hand, the low capacity of LTO can be increased by extending the operating voltage range to near zero vs. Li⁺/Li. In this way, unoccupied 8a sites could be used to store more lithium ions in the LTO structure, increasing its capacity. However, this could lead to some complications such as the formation of a LiTiO₂ phase at LTO grain boundaries, which translates into the possibility of irreversible capacity loss [11]. In addition, such excessive lithiation can cause deformation and consequent stress in the structure [12], creating concerns about possible loss of capacity over time. Our research on carbon materials unexpectedly showed that it is possible to encapsulate (“enclose”) LTO spinel grains in a tightly adherent and conductive carbon aerogel matrix obtained from starch. In such a composite system, the carbon aerogel matrix, thanks to its mechanical properties, exerts pressure on the LTO crystallites during the process of excess lithiation (“overlithiation”) in the low-potential range, which influences their stabilization and enables very good reversibility of the process and increased capacity. Appropriate mechanical properties require the use of carbon matrix layers with relatively greater thicknesses than in standard electrode composites, which can limit their permeability to lithium ions.

Unexpectedly, it turned out that the unique porous structure of the carbon aerogel provides adequate electrolyte penetration and the necessary diffusion channels for lithium ions and thus does not limit the electrochemical process. The composite material produced according to the invention shows a significant improvement in properties, which translates into its high application potential. In its assumptions, the invention may become an alternative to commonly used systems, i.e. LTO with Carbon Black additive [13]. Moreover, the preparation process based on commonly available and renewable raw materials is simple, relatively inexpensive, environmentally-friendly and easy to scale up, whereby fulfilling the principles of green chemistry techniques. Furthermore, the composition of the mixture that is the precursor of the carbon matrix allows controlling the structure and the morphology and electrochemical properties of the resulting composite. The synthesis method for CAG/LTO composites is based on the preparation of carbon aerogels, in which carbon precursor is starch [14-18].

The CAG/LTO composites are obtained by polycondensation of a suspension of the appropriate starch composition in water, with the addition of lithium-titanium oxide, at 60-90° C. The prepared hydrogel is aged at room temperature, after which a solvent exchange is carried out in order to generate the appropriate structure, providing the desired morphological properties of the composite. Subsequently, the pre-composite is dried under normal pressure and then subjected to a process of controlled thermal treatment (pyrolysis), under inert conditions, at 600-900° C. In the course of the pyrolysis process, during carbonization of the CAG precursor, the volume of the precursor is reduced, which, combined with the appropriate initial thickness of the precursor layer (its amount in relation to LTO), eventually leads to the formation of a compression layer of CAG exerting a sustained pressure on the LTO crystallites. The peculiar morphology of the CAG precursor, unexpectedly results in the formation of a unique porous structure of the CAG compression matrix during the pyrolysis process, which provides the necessary diffusion channels for lithium ions, even for relatively thick layers (composition of 10-50% C in relation to LTO). In its assumptions, the composite material of the invention can be used as an anode material for lithium (Li-ion) batteries.

The composite materials obtained with the method described are characterized by very good electrochemical properties and enhanced structural stability, which should improve the performance of lithium batteries. The use of the aerogel carbon matrix significantly improves the conductivity of the Li₄Ti₅O₁₂ material. In turn, expanding the potential window allows to increase the capacity not only by increasing the amount of lithium introduced into the LTO, but also by simultaneously engaging the carbon material to intercalate lithium ions into its structure. As a result, an increase in the system capacity is observed from 175 mAh/g (theoretical capacity of LTO) [8] to about 250 mAh/g at a current load of 1 C and to about 190 mAh/g at a current load of 10 C (for the CAG/LTO composite, with no optimization of the electrode layer thickness). Moreover, the materials of the invention are characterized by high Coulombic reversibility, as well as remarkable efficacy of the cell's operation under high-current conditions (capable of handling current loads of 20 C). In addition, during “overlithiation” (which, as mentioned, occurs over a wide potential range), no deformation in the structure is observed due to the tight bonding of LTO to the carbon matrix and the pressure of the CAG matrix stabilizing the spinel structure. As a result, these materials work very stably and have high cyclicity-after more than 1,000 operation cycles still achieving a capacity of ˜200 mAh/g at a current load of 5 C (no capacity loss during such a time). Achieving such parameters is undoubtedly competitive, compared to other LTO-based composite materials [19-25]. Notably, attempts to use carbon aerogel as a typical conductive additive have not been so successful.

Modification of LTO, through the use of the CAG compression matrix with bioorganic carbon as a precursor, allows to improve the properties of spinel-type lithium-titanium oxide, which enables its more effective application in lithium batteries. It is anticipated that the developed method can be used to produce CAG/Si composites in an analogous way, with the analogous compression mechanism of interaction with Si crystallites/grains during the lithiation/delithiation process leading to increased stability of the system and reversibility of the process.

The advantage of the stressed composite of the invention in the form of CAG/LTO is, above all, the tight adhesion (compressive adhesion) of the CAG layer to LTO grains, which allows very good access of lithium ions to LTO. It is also advantageous that there is no deformation of the LTO structure or formation of side, inactive phases, resulting in no capacity decrease even after 1000 cycles of cell operation and improved conductivity of the LTO material. A particular advantage of the present invention is that the capacity of the system is increased from 175 mAh/g to 250 mAh/g at a current load of 1 C, while at a current load of 10 C the capacity is increased to 190 mAh/g, so that the CAG/LTO composite material produced allows the cell to operate effectively under high-current conditions (capable of handling current loads of 20 C). An additional benefit of the subject invention is the high stability of the cell's operation, high cyclicity and very good process reversibility.

### EXAMPLE 1

Parameters of Commercially Available Li₄Ti₅O₁₂ (LTO) Given by the Manufacturer (MTI Corporation):
grain size: 0.2-34.0 μm,
conductivity: 2·10-5 S/cm,
specific surface area: 9.0-13.0 m²/g,
density ≥0.9 m²/g.

In order to obtain the CAG/LTO 5 composite material, an aqueous suspension of commercial lithium-titanium oxide powder Li₄Ti₅O₁₂, LTO (manufacturer MTI, >98%) and potato starch PS (Sigma Aldrich) with a weight ratio of LTO:PS 5:95 was prepared in a ratio of 10% by weight of the LTO and PS mixture and 90% by weight of distilled water. The prepared suspension was then placed in an oil bath and heated to 85° C. with constant stirring. The whole mixture was left in the bath for about 30 minutes from the time of pasting. After this time, the obtained sol was removed from the bath and aged for 24 h, leaving it in the air at room temperature. After aging, the obtained gel was covered with ethanol solution (manufacturer Borzęcin, 96% v/v) and set aside sealed with parafilm for 5 days for solvent exchange. Any alcohol chosen from the group including: methanol, ethanol, propanol can be used in the solvent exchange process. The resulting alkogel was dried in an oven for 24 h at 50° C. under atmospheric pressure. The organic aerogel obtained after drying was sequentially pyrolyzed in a tube furnace for 6 h at 700° C. (temperature build-up rate of 2° C./min) and in argon atmosphere (Air Products, 99.999%). The inert gas in the pyrolysis process can be argon, nitrogen, helium or a mixture of these gases of any composition. The pyrolysis process can also be carried out under reducing gas conditions. After pyrolysis, the composite, which was in the form of a monolith, was ground into powder using an agate mortar.

The resulting composite had an elemental carbon content of 74% by weight of the whole composite, while LTO in the composite accounted for 25%. The content of other elements (hydrogen and nitrogen) was determined as 1%. The size of LTO crystallites in the composite determined from the Scherrer equation was 47 nm. The specific surface area determined by N₂-BET low-temperature nitrogen sorption measurements reached 425.4 m²/g, the pore volume was 0.201 cm³/g, and the average pore size was 2 nm.

Electrochemical tests in the range of 0.001-3.0 V showed that the resulting composite had a gravimetric capacity of: 281 mAh/g after 11 cycles at C/5 current load, 208 mAh/g after 31 cycles at 1 C current load, 78 mAh/g after 71 cycles at 20 C current load, and 224 mAh/g after 81 cycles at 1 C current load.

### EXAMPLE 2

The CAG/LTO 25 composite material was prepared similarly to Example 1, with the LTO:PS weight ratio of the starting mixture being 25:75.

The resulting composite had an elemental carbon content of 31% by weight of the whole composite, while LTO in the composite accounted for 69%. The content of other elements (hydrogen and nitrogen) was negligible. The size of LTO crystallites in the composite determined from the Scherrer equation was 43 nm. The specific surface area determined by N₂-BET low-temperature nitrogen sorption measurements reached 180.4 m²/g, the pore volume was 0.107 cm³/g, and the average pore size was 2 nm.

Electrochemical tests in the range of 0.001-3.0 V showed that the resulting composite had a gravimetric capacity of: 243 mAh/g after 11 cycles at C/5 current load, 214 mAh/g after 31 cycles at 1 C current load, 118 mAh/g after 71 cycles at 20 C current load, and 214 mAh/g after 81 cycles at 1 C current load.

### EXAMPLE 3

The CAG/LTO 50 composite material was prepared similarly to Example 1, with the LTO:PS weight ratio of the starting mixture being 50:50.

The resulting composite had an elemental carbon content of 16% by weight of the whole composite, while LTO in the composite accounted for 84%. The content of other elements (hydrogen and nitrogen) was negligible. The size of LTO crystallites in the composite determined from the Scherrer equation was 55 nm. The specific surface area determined by N₂-BET low-temperature nitrogen sorption measurements reached 107.5 m²/g, the pore volume was 0.083 cm³/g, and the average pore size was 3 nm.

Electrochemical tests in the range of 0.001-3.0 V showed that the resulting composite had a gravimetric capacity of: 264 mAh/g after 11 cycles at C/5 current load, 240 mAh/g after 31 cycles at 1 C current load, 157 mAh/g after 71 cycles at 20 C current load, and 244 mAh/g after 81 cycles at 1 C current load.

### EXAMPLE 4

The CAG/LTO 75 composite material was prepared similarly to Example 1, with the LTO:PS weight ratio of the starting mixture being 75:25.

The resulting composite had an elemental carbon content of 7% by weight of the whole composite, while LTO in the composite accounted for 93%. The content of other elements (hydrogen and nitrogen) was negligible. The size of LTO crystallites in the composite determined from the Scherrer equation was 66 nm. The specific surface area determined by N₂-BET low-temperature nitrogen sorption measurements reached 44.5 m²/g, the pore volume was 0.031 cm³/g, and the average pore size was 3 nm.

Electrochemical tests in the range of 0.001-3.0 V showed that the resulting composite had a gravimetric capacity of: 224 mAh/g after 11 cycles at C/5 current load, 210 mAh/g after 31 cycles at 1 C current load, 151 mAh/g after 71 cycles at 20 C current load, and 212 mAh/g after 81 cycles at 1 C current load.

### EXAMPLE 5

A CAG/LTO material was prepared that was a physical mixture of commercial lithium-titanium oxide powder Li₄Ti₅O₁₂, LTO (MTI, >98%) and a carbon aerogel based on potato starch PS (Sigma Aldrich) in a LTO:CAG weight ratio of 84:16.

The resulting composite had an elemental carbon content of 16% by weight of the whole composite, while LTO in the composite accounted for 84%. The content of other elements (hydrogen and nitrogen) was negligible. The specific surface area determined by N₂-BET low-temperature nitrogen sorption measurements reached 84.8 m²/g, the pore volume was 0.044 cm³/g, and the average pore size was 2 nm.

Electrochemical tests in the range of 0.001-3.0 V showed that the resulting composite had a gravimetric capacity of: 96 mAh/g after 11 cycles at C/5 current load, 60 mAh/g after 31 cycles at 1 C current load, 9 mAh/g after 71 cycles at 20 C current load, and 57 mAh/g after 81 cycles at 1 C current load.

### EXAMPLE 6

A CB/LTO composite material was prepared that was a physical mixture of commercial Li₄Ti₅O₁₂ lithium-titanium oxide powder, LTO (MTI, >98%) and commercial carbon black CB conductive additive (Alfa Aesar, Super PR Conductive, 99+%, metals basis) in a LTO: CB weight ratio of 84:16.

The resulting composite had an elemental carbon content of 16% by weight of the whole composite, while LTO in the composite accounted for 84%. The content of other elements (hydrogen and nitrogen) was negligible.

Electrochemical tests in the range of 0.001-3.0 V showed that the resulting composite had a gravimetric capacity of: 238 mAh/g after 11 cycles at C/5 current load, 224 mAh/g after 31 cycles at 1 C current load, 159 mAh/g after 71 cycles at 20 C current load, and 223 mAh/g after 81 cycles at 1 C current load.

### EXAMPLE 7

A material representing only pure commercial Li₄Ti₅O₁₂ lithium-titanium oxide powder, LTO (MTI, >98%), was prepared.

The size of LTO crystallites determined from the Scherrer equation was 70 nm. The specific surface area determined by N₂-BET low-temperature nitrogen sorption measurements reached 8.5 m²/g, the pore volume was 0.016 cm³/g, and the average pore size was 8 nm.

Electrochemical tests in the range of 0.001-3.0 V showed that the resulting composite had a gravimetric capacity of: 73 mAh/g after 11 cycles at 5 C current load, 42 mAh/g after 31 cycles at 1 C current load, 2 mAh/g after 71 cycles at 20 C current load, and 43 mAh/g after 81 cycles at 1 C current load.

### EXAMPLE 8

Fabrication of electrodes from the material obtained according to examples 1-7 and assembly of the cell.

For the preparation of electrodes, the obtained composites according to examples 1-7 were mixed with a binder (polymer binder), which was poly(vinylidene fluoride), PVDF (Sigma-Aldrich) at a weight ratio of composite material to PVDF of 9:1. The prepared mixture was then suspended in N-Methylpyrrolidone, NMP (Sigma Aldrich, ≤99.5%) and homogenized in a ball mill at a stirring speed of 750 rpm for two 2-minute cycles with a 1-minute interval in between. The resulting slurries were spread on previously cleaned copper foils, which were current collectors, using a knife on an automatic thin film preparation table. The slurries applied to the foils were further dried for 24 hours at 90° C. under atmospheric pressure. After drying, 12-mm-diameter disks with the applied composite material were cut from each foil and used as electrodes.

The cells were assembled in R-2032 type housings (so-called coin cells) in a glove box (UNILAB with circulator, MBRAUN), under an oxygen-free and anhydrous atmosphere. Each cell contained a metallic lithium reference electrode, separated from the test electrode by a Celgard 2325 polymer membrane assembled with two Whatman GF/F glass fiber membranes. The electrolyte was a 1 M solution of LiPF₆ salt in a mixture of ethylene carbonate EC and diethyl carbonate DEC in a volume ratio of 1:1, which was introduced into the cell by saturating the used separators with it.

### COMPARATIVE EXAMPLE 1

Li Wang, Zonglin Zhang, Guangchuan Liang, Xiuqin Ou, Yingqiu Xu; Synthesis and electrochemical performance of Li₄Ti₅O₁₂/C composite by a starch sol assisted method, Powder Technology, 215-216, 2012, 79-84.

Stoichiometric amounts of TiO₂ (anatase) and Li₂CO₃ (molar ratio Li:Ti=4.2:5), as well as starch (starch:Li₄Ti₅O₁₂=5; 7.5; 10; 12.5; 15% by weight) were used to obtain Li₄Ti₅O₁₂/C starch composites. Starch was mixed with an appropriate amount of distilled water (the exact volume of water was not specified in the cited article), and then heated at 80° C. until a homogeneous, transparent sol was obtained. Subsequently, a mixture of TiO₂ and Li₂CO₃ was added to the above suspension, with constant heating and stirring of the system, until a white gel was obtained. The resulting product was dried at 120° C. and then subjected to a two-step pyrolysis process in a tube furnace under a stream of nitrogen. In the first step, the precursor was pyrolyzed at 600° C. for 4 h, and in the second step at 800° C. for 6 h. The resulting Li₄Ti₅O₁₂/C composite was cooled to room temperature and ground.

The studied Li₄Ti₅O₁₂/C materials were characterized by X-ray diffraction (XRD), thermogravimetric analysis (TG), scanning electron microscopy (SEM), transmission electron microscopy (TEM) and charge/discharge tests (CELL TEST). Diffractograms of the obtained Li₄Ti₅O₁₂/C composites (with different starch contents) confirm that the studied materials have the crystalline structure of the Li₄Ti₅O₁₂ spinel, and that the addition of carbon present does not cause changes in their structure (low amorphous carbon content).

The average size of the crystallites and the lattice constant were not determined in the article. Using thermogravimetric analysis, the actual carbon content was determined —Li₄Ti₅O₁₂/C composites with starch contents of 5.0; 7.5; 10.0; 12.5 and 15.0% by weight have 1.03; 2.19; 3.21; 4.37 and 5.18% by weight of carbon, respectively. As the carbon content increased, the colour of the test samples became darker. Li₄Ti₅O₁₂/C composites with lower starch content (5.0 and 7.5%) were characterized by a “smooth” surface with relatively large grain sizes. In contrast, composites with higher starch contents (10.0; 12.5 and 15.0%) had a more “rough” surface at the same time with smaller grain sizes. The Li₄Ti₅O₁₂/C composite with 3.21% carbon content had an average particle size in the range of 200-300 nm. As the carbon content increased, agglomerates appeared in the samples.

To prepare the electrodes, the Li₄Ti₅O₁₂/C active material was mixed with carbon additive—acetylene black and binder—polytetrafluoroethylene (PTFE) in a mass ratio of 80:15:5. The electrochemical cells were assembled in a glove box under argon atmosphere. Pure lithium was used as the reference electrode, Celgard 2400 microporous polyethylene membrane as the separator and 1 M solution of LiPF₆ in a mixture of ethylene carbonate (EC) and dimethyl carbonate (DMC), in a volume ratio of 1:1 as the electrolyte. The cells were left after assembly for at least 5 hours. Charge/discharge tests were carried out in the potential range of 1.0-2.5 V (vs. Li/Li⁺), at room temperature, with different current loads: 0.2 C (C/5); 1 C; 2 C and 5 C. Discharge capacity under 0.2 C load for materials with carbon content of 1.03; 2.19; 3.21; 4.37 and 5.18% were: 155.6; 160.9; 168.5; 165.0 and 161.9 mAh/g, respectively. The highest discharge capacity was achieved by the composite with a carbon content of 3.21% (168.5 mAh/g). As the current increased, the discharge capacity for this composite decreased from 168.5 (0.2 C) to 160.8 (1 C), 155.1 (2 C) and 141.8 mAh/g (5 C). Moreover, under 1 C load, after 25 cycles of operation, its capacity decreased from 159.8 to 157.2 mAh/g.

### COMPARATIVE EXAMPLE 2

Z. Wang, G. Xie, L. Gao; Electrochemical Characterization of Li₄Ti₅O₁₂/C Anode Material Prepared by Starch-Sol-Assisted Rheological Phase Method for Li-Ion Battery, Journal of Nanomaterials, 2012, 2012, 4545-4557.

Starch (3.0 g starch/0.02 mole Li₄Ti₅O₁₂) was mixed with an appropriate amount of deionized water (the exact volume of water was not specified in the cited article). The resulting mixture was heated in an oil bath at 110° C. until a transparent suspension was obtained. Subsequently, the starch paste was mixed with a stoichiometric amount of LiOH and TiO₂ (molar ratio Ti: Li=4.2:5). The thick suspension was transferred to a tube furnace and reheated at a rate of 15°/min to 850° C. under nitrogen atmosphere, and then sintered at this temperature for 4 h. The resulting Li₄Ti₅O₁₂/C composite was cooled to room temperature and characterized by X-ray diffraction (XRD), thermogravimetric analysis (TG), scanning electron microscopy (SEM), transmission electron microscopy (TEM) and charge/discharge tests (CELL TEST).

The diffractogram of the obtained Li₄Ti₅O₁₂/C composite confirms that it has the crystalline structure of the Li₄Ti₅O₁₂ spinel (space group Fd3m), and the carbon addition present in it does not cause changes in its structure (low amorphous carbon content). The average crystallite size calculated from the Scherrer equation was 400˜600 nm, and the lattice constant was 8.359 Å. Using thermogravimetric analysis, the actual carbon content, i.e. 5%, was determined. The resulting powder was grey in colour. The carbon uniformly covered the surface of the LTO grains, forming a layer of 5 nm. Li₄Ti₅O₁₂/C particles had a relatively low degree of agglomeration, and their average size was about 500 nm.

To prepare the electrodes, 84% by weight of the active material (Li₄Ti₅O₁₂/C), 10% by weight of a conductive additive (super-P-Li carbon black) and a binder containing: 3% by weight of CMC (sodium salt of carboxymethylcellulose) and 3% by weight of SBR (styrene-butadiene rubber) were mixed using deionized water as a solvent. The suspension was dispersed and then spread evenly on aluminum foil. The electrodes thus obtained were dried under vacuum at 100° C. for 24 h. Coin cells were assembled in a glove box under argon atmosphere. Pure lithium was used as the reference electrode, Celgard 2320 microporous polyethylene membrane as the separator and 1.3 M solution of LiPF₆ in a mixture of ethylene carbonate (EC) and dimethyl carbonate (DMC) in a 1:3 mass ratio as the electrolyte. Charge/discharge tests were carried out in the potential range of 1.0-2.0 V (vs. Li/Li⁺), at room temperature, at various current intensities. At a load of 0.2 C (C/5), the initial discharge capacity of the composite was 171.5 mAh/g. The voltage curves were characterized by a flat plateau of about 1.55 V (vs. Li/Li⁺). For 1 C load, the initial discharge capacity of Li₄Ti₅O₁₂/C was 168.6 mAh/g, retaining 87% of its value after 500 operation cycles. In contrast, for 20 C load, the initial discharge capacity was 110 mAh/g, with no apparent decrease in capacity observed in the first 1000 cycles (only after 2000 cycles did the material reach 73% of its initial capacity).

### COMPARATIVE EXAMPLE 3

P. Liu, Z. A. Zhang, J. Li, Y. Q. Lai; Effects of carbon sources on electrochemical performance of Li₄Ti₅O₁₂/C composite anode materials, Journal of Central South University of Technology, 17 (6), 2010, 1207-1210.

Li₄Ti₅O₁₂ and 2% by weight of starch were mixed with an appropriate amount of ethanol (the exact volume and concentration of ethanol were not specified in the cited article), and then milled in a mill for 2 h. The mixture was then dried at 120° C. for 8 h. The resulting powder was placed in a tube furnace for sintering it at 800° C. for 6 h under nitrogen atmosphere. The Li₄Ti₅O₁₂/C composite was cooled to room temperature and characterized by X-ray diffraction (XRD) and charge/discharge tests (CELL TEST).

The diffractogram of the obtained Li₄Ti₅O₁₂/C composite confirms that it has the crystalline structure of the Li₄Ti₅O₁₂ spinel (space group Fd3̅m), and the carbon addition present in it does not cause changes in its structure (low amorphous carbon content). The average crystallite size and lattice parameter were not determined. The actual carbon content was not determined. The resulting powder was dark grey/black in colour.

In order to prepare the electrodes, the Li₄Ti₅O₁₂/C active material was mixed with a carbon additive—carbon black and a binder—polyvinylidene fluoride (PVDF) in a mass ratio of 80:10:10. The mixture was milled using N-methyl-2-pyrrolidone (NMP) as a solvent. The suspension was spread evenly on copper foil. The electrodes thus obtained were dried under vacuum at 120° C. for 24 h. Coin cells were assembled in a glove box under argon atmosphere. Pure lithium was used as the reference electrode, Celgard 2400 microporous polyethylene membrane as the separator and 1 M solution of LiPF₆ in a mixture of ethylene carbonate (EC), dimethyl carbonate (DMC) and ethylmethyl carbonate (EMC) in a mass ratio of 1:1:1 as the electrolyte. Charge/discharge tests were conducted in the potential range of 0.8-2.5 V (vs. Li/Li⁺), at room temperature. Voltage curves were characterized by a flat plateau at about 1.53-1.57 V (vs. Li/Li⁺). The initial discharge capacity of Li₄Ti₅O₁₂/C under 0.1 C (C/10) load was 159.0 mAh/g.

### COMPARATIVE EXAMPLE 4

B. Prihandoko, A. Subhan, S. Priyono; Electrochemical Behavior of Li₄Ti₅O₁₂ under In Situ Process of Sintering and Surface Coating with Cassava Powder, Advanced Materials Research, 789, 2013, 21-27.

LTO was prepared by powder metallurgy using TiO₂ and LiOH H₂O as raw materials. Stoichiometric amounts were measured (the exact weights were not specified in the cited article), and the mixture was calcined at 700° C. for 1 h. The resulting material was mixed with tapioca flour (as the carbon source) in a 1:1 ratio and then pyrolyzed under nitrogen atmosphere. The thermal treatment process was carried out at 800 and 850° C. for 1 hour. The obtained Li₄Ti₅O₁₂/C composites were characterized by X-ray diffraction (XRD), scanning electron microscopy with integrated energy dispersive X-ray spectrometer (SEM-EDX) and cyclic voltammetry (CV).

Diffractograms of the obtained Li₄Ti₅O₁₂/C composites confirm that the studied materials have the crystalline structure of the Li₄Ti₅O₁₂ spinel, and the addition of carbon present in the composite does not cause changes in the structure (low amorphous carbon content). In the sample sintered at 800° C., an impurity appeared—anatase phase coming from the raw material. In the 850° C. sample, the presence of TiO₂ was very small. The average crystallite size and lattice parameter were not determined. On the basis of EDX analysis, the actual carbon content—25.3 and 11.1% by weight—was determined for the materials sintered at 800 and 850° C., respectively. The obtained powders were black in colour. The carbon coating on the surface of the grains had a porous morphology. The article does not include information on the method of electrode preparation. Electrochemical characteristics were determined by cyclic voltammetry measurements. The Li₄Ti₅O₁₂/C composite prepared by sintering at 850° C. had an operating voltage of 1.55 V and a capacity of about 5 mAh/g.

TABLE 1
Test results for the materials of Examples 1-7

| | | | | | | | | Specific capacity vs. Li/Li+ | | | |
|---|---|---|---|---|---|---|---|---|---|---|---|
| | | | | | | | | in the potential range of | | | |
| | | | | LTO | Specific | | Average | 0.001-3.0 V [mAh/g] | | | |
| | | Carbon | LTO | crystallite | surface | Pore | pore | after 11 | after 31 | after 71 | after 81 |
| | | content | content | size | area | volume | size | cycles | cycles | cycles | cycles |
| Example | Sample | [%] | [%] | [nm] | [m²/g] | [cm³/g] | [nm] | (C/5) | (1 C) | (20 C) | (1 C) |
| 1 | CAG/LTO 5 | 74 | 25 | 47 | 425.4 | 0.201 | 2 | 281 | 208 | 78 | 224 |
| | composite | | | | | | | | | | |
| 2 | CAG/LTO 25 | 31 | 69 | 43 | 180.4 | 0.107 | 2 | 243 | 214 | 118 | 214 |
| | composite | | | | | | | | | | |
| 3 | CAG/LTO 50 | 16 | 84 | 55 | 107.5 | 0.083 | 3 | 264 | 240 | 157 | 244 |
| | composite | | | | | | | | | | |
| 4 | CAG/LTO 75 | 7 | 93 | 66 | 44.5 | 0.031 | 3 | 224 | 210 | 151 | 212 |
| | composite | | | | | | | | | | |
| 5 | CAG/LTO | 16 | 84 | — | 84.8 | 0.044 | 2 | 96 | 60 | 9 | 57 |
| | physical | | | | | | | | | | |
| | mixture | | | | | | | | | | |
| 6 | CB/LTO | 16 | 84 | — | — | — | — | 238 | 224 | 159 | 223 |
| | physical | | | | | | | | | | |
| | mixture | | | | | | | | | | |
| 7 | pure LTO | 0 | 100 | 70 | 8.5 | 0.016 | 8 | 73 | 42 | 2 | 43 |
| | commercial | | | | | | | | | | |
| | material | | | | | | | | | | |

TABLE 2
Test results for the materials of Comparison example 1

| | | | | | | | | Specific capacity vs. Li/Li+ | | | |
|---|---|---|---|---|---|---|---|---|---|---|---|
| | | | | LTO | Specific | | Average | in the potential range of | | | |
| | | Carbon | LTO | crystallite | surface | Pore | pore | 1-2.5 V [mAh/g] | | | |
| | | content | content | size | area | volume | size | (0.2 | (1 | (2 | (5 |
| Example | Sample | [%] | [%] | [nm] | [m²/g] | [cm³/g] | [nm] | C) | C) | C) | C) |
| 1 | LTO/C 5 | 1.03 | 95 | — | — | — | — | 155.6 | — | — | — |
| 2 | LTO/C 7.5 | 2.19 | 92.5 | — | — | — | — | 160.9 | — | — | — |
| 3 | LTO/C 10 | 3.21 | 90 | 200-300 | — | — | — | 168.5 | 160.8 | 155.1 | 141.8 |
| 4 | LTO/C 12.5 | 4.37 | 87.5 | — | — | — | — | 165.0 | — | — | — |
| 5 | LTO/C 15 | 5.18 | 85 | — | — | — | — | 161.9 | — | — | — |

TABLE 3
Test results for the materials of Comparison example 2

| | | | | | | | | Specific capacity vs. Li/Li+ | | |
|---|---|---|---|---|---|---|---|---|---|---|
| | | | | LTO | Specific | | Average | in the potential range of | | |
| | | Carbon | LTO | crystallite | surface | Pore | pore | 1-2.0 V [mAh/g] | | |
| | | content | content | size | area | volume | size | (0.2 | (1 | (20 |
| Example | Sample | [%] | [%] | [nm] | [m²/g] | [cm³/g] | [nm] | C) | C) | C) |
| 1 | LTO/C | 5 | 0.02 | 400-600 | — | — | — | 171.5 | 168.6 | 110.0 |

TABLE 4
Test results for the materials of Comparison example 3

| | | | | LTO | Specific | | Average | Specific capacity vs. Li/Li+ |
|---|---|---|---|---|---|---|---|---|
| | | Carbon | LTO | crystallite | surface | Pore | pore | in the potential range of |
| | | content | content | size | area | volume | size | 0.8-2.5 V [mAh/g] |
| Example | Sample | [%] | [%] | [nm] | [m²/g] | [cm³/g] | [nm] | Initial discharge capacity (0.1 C) |
| 1 | LTO/C 2% | — | 98 | — | — | — | — | 154.3 |
| | glucose | | | | | | | |
| 2 | LTO/C 2% | — | 98 | — | — | — | — | 158.6 |
| | sucrose | | | | | | | |
| 3 | LTO/C 2% | — | 98 | — | — | — | — | 159.0 |
| | starch | | | | | | | |

TABLE 5
Test results for the materials of Comparison example 4

| | | | | LTO | Specific | | Average | |
|---|---|---|---|---|---|---|---|---|
| | | Carbon | LTO | crystallite | surface | Pore | pore | Specific |
| | | content | content | size | area | volume | size | capacity |
| Example | Sample | [%] | [%] | [nm] | [m²/g] | [cm³/g] | [nm] | [mAh/g] |
| 1 | LTO/C 50% | 25.3 | 50 | — | — | — | — | — |
| | (800° C.) | | | | | | | |
| 2 | LTO/C 50% | 11.1 | 50 | — | — | — | — | 5 |
| | (850° C.) | | | | | | | |

### LIST OF LITERATURE CITED IN THE DESCRIPTION

1. Cheng, Q.; Tang, S.; Liang, J.; Zhao, J.; Lan, Q.; Liu, C.; Cao, Y.C. High rate performance of the carbon encapsulated Li₄Ti₅O₁₂ for lithium ion battery. Results Phys 2017, 7, 810-812. doi:10.1016/j.rinp.2017.01.040.
2. Wang, C.; Wang, S.; Tang, L.; He, Y. B.; Gan, L.; Li, J.; Du, H.; Li, B.; Lin, Z.; Kang, F. A robust strategy for crafting monodisperse Li₄Ti₅O₁₂ nanospheres as superior rate anode for lithium ion batteries. Nano Energy 2016, 21, 133-144. doi:10.1016/j.nanoen.2016.01.005.
3. Tang, Y.; Yang, L.; Fang, S.; Qiu, Z. Li₄Ti₅O₁₂ hollow microspheres assembled by nanosheets as an anode material for high-rate lithium ion batteries. Electrochim. Acta 2009, 54, 6244-6249. doi:10.1016/j.electacta.2009.05.092.
4. Gangaja, B.; Nair, S.; Santhanagopalan, D. Surface-Engineered Li₄Ti₅O₁₂ Nanostructures for High-Power Li-Ion Batteries. Nanomicro Lett. 2020, 12, 1-11. doi:10.1007/s40820-020-0366-x.
5. Wei, A.; Li, W.; Zhang, L.; Ren, B.; Bai, X.; Liu, Z. Enhanced electrochemical performance of a LTO/N-doped graphene composite as an anode material for Li-ion batteries. Solid State Ion. 2017, 311, 98-104. doi:10.1016/j.ssi.2017.09.017.
6. Zaghib, K.; Dontigny, M.; Guerfi, A.; Charest, P.; Rodrigues, I.; Mauger, A.; Julien, C. M. Safe and fast-charging Li-ion battery with long shelf life for power applications. J. Power Sources 2011, 196, 3949-3954. doi:10.1016/j.jpowsour.2010.11.093.
7. Sandhya, C. P.; John, B.; Gouri, C. Lithium titanate as anode material for lithium-ion cells: A review. Ionics 2014, 20, 601-620. doi:10.1007/s11581-014-1113-4.
8. Sun, X.; Radovanovic, P. v.; Cui, B. Advances in spinel Li₄Ti₅O₁₂ anode materials for lithium-ion batteries. New J. Chem. 2015, 39, 38-63. doi:10.1039/c4nj01390e.
9. Cheng, L.; Li, X.-L.; Liu, H.-J.; Xiong, H.-M.; Zhang, P.-W.; Xia, Y.-Y. Carbon-Coated Li₄Ti₅O₁₂ as a High Rate Electrode Material for Li-Ion Intercalation. J. Electrochem. Soc. 2007, 154, A692. doi:10.1149/1.2736644.
10. Zhu, N.; Liu, W.; Xue, M.; Xie, Z.; Zhao, D.; Zhang, M.; Chen, J.; Cao, T. Graphene as a conductive additive to enhance the high-rate capabilities of electrospun Li₄Ti₅O₁₂ for lithium-ion batteries. Electrochim. Acta 2010, 55, 5813-5818. doi:10.1016/j.electacta.2010.05.029.
11. Ganapathy, S.; Wagemaker, M. Nanosize Storage Properties in Spinel Li₄Ti₅O₁₂ Explained by Anisotropic Surface Lithium Insertion. ACS Nano 2012, 6, 8702-8712. doi:10.1021/nn302278m.
12. Choi, Z.; Kramer, D.; Monig, R. Correlation of stress and structural evolution in Li₄Ti₅O₁₂-based electrodes for lithium ion batteries. J. Power Sources 2013, 240, 245-251. doi:10.1016/j.jpowsour.2013.03.185.
13. Ge, H.; Li, N.; Li, D.; Dai, C.; Wang, D. Electrochemical characteristics of spinel Li₄Ti₅O₁₂ discharged to 0.01 V. Electrochem. Commun. 2008, 10, 719-722. doi:10.1016/j.elecom.2008.02.026.
14. Bakierska, M.; Molenda, M.; Majda, D.; Dziembaj, R. Functional starch based carbon aerogels for energy applications. Procedia Eng. 2014, 98, 14-19. doi:10.1016/j.proeng.2014.12.481.
15. Bakierska, M.; Chojnacka, A.; Świętosławski, M.; Natkański, P.; Gajewska, M.; Rutkowska, M.; Molenda, M. Multifunctional carbon aerogels derived by sol-gel process of natural polysaccharides of different botanical origin. Materials 2017, 10, 1336. doi:10.3390/ma10111336.
16. Bakierska, M.; Lis, M.; Pacek, J.; Świętosławski, M.; Gajewska, M.; Tąta, A.; Proniewicz, E.; Molenda, M. Bio-derived carbon nanostructures for high-performance lithium-ion batteries. Carbon 2019, 145, 426-432. doi:10.1016/j.carbon.2019.01.051.
17. Kubicka, M.; Bakierska, M.; Chudzik, K.; Rutkowska, M.; Pacek, J.; Molenda, M. Electrochemical properties and structure evolution of starch-based carbon nanomaterials as Li-Ion anodes with regard to thermal treatment. Polymers 2019, 11, 16-23. doi:10.3390/polym11091527.
18. M. Bakierska, M. Molenda, A. Chojnacka, M. Świętosławski, Zgłoszenie międzynarodowe w trybie PCT, Karbożelowe materiały anodowe i sposób ich wytwarzania/Carbogel anode materials and method for their preparation, PCT/IB2017/050591 (3.02.2017).

19. Zhu, G. N.; Du, Y. J.; Wang, Y. G.; Yu, A. S.; Xia, Y. Y. Electrochemical profile of lithium titanate/hard carbon composite as anode material for Li-ion batteries. J. Electroanal. Chem., 2013, 688, 86-92. doi:10.1016/j.jelechem.2012.07.035
20. Li, W., Wei, A., Li, X., Zhang, L., Wang, H., Ge, W., & Liu, Z. High-rate-capability graphene oxide/Li₄Ti₅O₁₂-composite anode for lithium-ion batteries. Int. J. Electrochem. Sci, 2017, 12, 2822-2835. doi:10.20964/2017.04.32.
21. Hu, M.; Jiang, Y.; Yan, M. High rate Li₄Ti₅O₁₂—Fe₂O₃ and Li₄Ti₅O₁₂—CuO composite anodes for advanced lithium ion batteries. J. Alloys Compd. 2014, 603, 202-206. doi:10.1016/j.jallcom.2014.03.085.
22. Wang, Z.; Chen, G.; Xu, J.; Lv, Z.; Yang, W. Synthesis and electrochemical performances of Li₄Ti_{4.95}Al_{0.05}O₁₂/C as anode material for lithium-ion batteries. J. Phys. Chem. Solids 2011, 72, 773-778. doi:10.1016/j.jpcs.2011.03.013.
23. Bhatti, H. S.; Anjum, D. H.; Ullah, S.; Ahmed, B.; Habib, A.; Karim, A.; Hasanain, S. K. Electrochemical Characteristics and Lit Ion Intercalation Kinetics of Dual-Phase Li₄Ti₅O₁₂/Li₂TiO₃ Composite in the Voltage Range 0-3 V. J. Phys. Chem. C 2016, 120, 9553-9561. doi:10.1021/acs.jpcc.5b12114.
24. Zhao, B.; Ran, R.; Liu, M.; Shao, Z. A comprehensive review of Li₄Ti₅O₁₂-based electrodes for lithium-ion batteries: The latest advancements and future perspectives. Mater. Sci. Eng. R 2015, 98, 1-71. doi:10.1016/j.mser.2015.10.001.
25. Chen, C; Agrawal, R.; Wang C. High Performance Li₄Ti₅O₁₂/Si Composite Anodes for Li-Ion Batteries. Nanomaterials 2015, 5, 1469-1480. doi:10.3390/nano5031469.

1. A composite material, characterized in that it contains a matrix formed by carbon aerogel and Li₄Ti₅O₁₂ spinel nanocrystallites dispersed in this matrix, with a carbon content in the composite of 7-74% by weight and a content of Li₄Ti₅O₁₂ spinel nanocrystallites in the composite of 25-93% by weight, with a specific surface area of the composite of 44-426 m²/g and a pore volume of the composite of 0.03-0.21 cm³/g, and an average pore size of the composite of 2-3 nm.

2. The composite of claim 1, wherein the Li₄Ti₅O₁₂ nanocrystallites have a size in the range of 40-70 nm.

3. A method of obtaining composite material, characterized in that an aqueous suspension containing Li₄Ti₅O₁₂ in the amount of 5-75% by weight and potato starch in the amount of 25-95% by weight undergoes a polycondensation process at 60-90° C., and then the obtained hydrogel undergoes an aging process, followed by a solvent exchange using an aqueous alcohol solution, and then the obtained alkogel is dried, and the dried gel is subjected to pyrolysis at 600-900° C.

4. The method of claim 3, wherein the polycondensation is carried out preferably at a temperature of up to 85° C.

5. The method of claim 3, wherein the polycondensation is carried out until a gel is obtained.

6. The method of claim 3, wherein the aging process is carried out for not less than 24 h.

7. The method of claim 3, wherein the aging process is carried out at room temperature and at atmospheric pressure.

8. The method of claim 3, wherein the solvent exchange process is carried out using an aqueous alcohol solution with a concentration in the range of 10-99.8%.

9. The method of claim 3, wherein an alcohol selected from the group including methanol, ethanol, propanol or a mixture thereof of any composition is used as the alcohol.

10. The method of claim 3, wherein that the pyrolysis is carried out under inert gas conditions or under reducing gas conditions.

11. The method of claim 10, wherein a gas selected from the group including nitrogen, argon, helium or a mixture of these gases of any composition is used as the inert gas.

12. (canceled)

13. A method of manufacturing an electrode material or a lithium-ion cell, the method comprising:
providing the composite material of claim 1; and
forming the composite material into an electrode or incorporating the composite material into a lithium-ion cell.
